(19) United States
(12) Patent Application Publication
(10) Pub. No.: US 2015/0260823 A1
(43) Pub. Date: Sep. 17, 2015

(54) METHOD OF ENCLOSING AND POWERING A BLUETOOTH EMITTER

(71) Applicant: Crestron Electronics, Inc., Rockleigh, NJ (US)

(72) Inventor: Ronald Hansen, Staten Island, NY (US)

(73) Assignee: Crestron Electronics, Inc., Rockleigh, NJ (US)

(21) Appl. No.: 14/204,337

(22) Filed: Mar. 11, 2014

(51) Int. Cl. G01S 1/04

(52) U.S. Cl. CPC G01S 1/04

(57) ABSTRACT

Configuring and powering micro-location emitter inside electrical wall box a wall plate using a wired connection or an inductive pickup. The emitters may implement or conform to various versions of the Bluetooth specification. Configurations may also include configuring an emitter inside a lighting fixture for harvesting the light generated by the lighting fixture or securing a micro-location emitter on windows for the harvesting of solar energy.

### BACKGROUND OF THE INVENTION

1. Field of the Invention

The present disclosure generally relates to emitter based micro location systems, and more particularly to enclosing and powering electrical hardware fixtures.

2. Description of the Prior Art

Location aware computing refers to applications that utilize a user's location to provide content relevant to that location. The positioning information needed for location-aware mobile computing can be provided by emitters acting as positioning beacons. The positioning information may be used to empower a mobile device with contextual info based on the environment the mobile device is currently located. The result is that a mobile device can dynamically update its location-context over time. Accordingly, a smart location-oriented infrastructure can be implemented by deploying a plurality of emitters throughout a building.

Numerous wireless technologies have been developed or adapted for use in micro-location applications. These technologies include wireless local area network (WLAN), Radio-frequency identification (RFID), Dart Ultra Wideband (UWB), ZigBee™, Bluetooth®, Shared Wireless Access Protocol (SWAP), HomeRF™, Global Positioning System (GPS), Assisted GPS (A-GPS), and the like. In general, these technologies vary from one another by balancing complexity, power requirements, and range of distance. For example, decreasing power requirements normally results in a shorter distance over which a particular system will effectively work.

Bluetooth® refers to a particular short range wireless radio standard that defines how compatible devices, among other things, communicate with each other. For example, version 4.0 (and later) of the Bluetooth® Core Specification (i.e., “Bluetooth Smart”) also provides for considerably less power consumption at the same radio communication range of prior versions. Bluetooth®, Bluetooth Smart®, and Bluetooth Smart Ready® marks are trademarks that are owned by the Bluetooth Special Interest Group (SIG). SIG is the body that oversees the development of Bluetooth® standards and the licensing thereof to manufacturers. The SIG was founded in September 1998 and is headquartered in Kirkland, Wash., USA.

Conventionally, power was supplied to emitters via a transformer plugged into a wall outlet or by plugging it into a computer's Universal Serial Bus (USB) serial port. Unfortunately, plugging into a standard wall A/C power outlet brings with it the loss of availability of the occupied outlet. It also presents a risk of emitter disruption or tampering. For example, emitters could easily be relocated, thereby causing distortion in the location map. Still further, if an outlet is temporarily needed, there is a risk of being unplugged, thereby creating holes in the location map. Likewise, powering emitters from a USB power source (e.g. a computer's USB ports, etc.) may pose a risk the emitter will be forgotten about until the computer is moved. USB powered Emitters also risk being unplugged if a user needs another USB port.

One way this problem could to avoid this problem was to use an internal battery within the emitter. Unfortunately, batteries traditionally needed to be periodically replaced. Depending on the number of emitters deployed, in some instances, it would result in a large number of scheduled battery changes. Still further, each change will have to be conservatively timed to occur prior to actual battery depletion, in order to prevent the occurrence of holes in the location map.

Additionally, emitter deployment heretofore remains a challenge because, in order for deployed emitters to be most useful, they should be dispersed uniformly throughout a building while still remaining relatively close to one another.

Thus, there remains a considerable need for improvement in the art because existing solutions fall short addressing the challenges of enclosing and powering emitters.

### SUMMARY OF THE INVENTION

It is to be understood that both the general and detailed descriptions that follow are exemplary and explanatory only and are not restrictive.

### DISCLOSURE OF INVENTION

The present invention provides a system and methods for deploying and powering micro-location emitters. Micro-location emitters can be used to provide location-context information to further improve the user experience and provide better engagement between the user and the current environment. For example, an internet-enabled mobile device, e.g. smart phone, may combine a user's location-context with information obtained from the mobile device's internet connection. The additional information may include, for example, a user's shopping history, current traffic conditions, or environmental status, and the like.

Wireless devices, such as smartphones and MP3 players, are commonly available today and are in widespread use. Most of these devices support the use of a Bluetooth® accessory, such as a headset, car kit, a home entertainment device, a desktop computer, and/or a Bluetooth-enabled speaker system. In some embodiments the micro-location emitters use a low power, low data rate wireless radio technology standard called Bluetooth Low Energy (BLE) (e.g., version 4.0 or later) to take advantage its low-power utilization requirements.

Accordingly, in a first aspect, the present invention provides an apparatus and method of configuring micro-location emitters inside electrical outlet wall boxes. Electrical wall boxes are typically always-available power sources. That is, they normally do not have an on/off switch. In this aspect, the building's electrical wall boxes are configured to provide power to the micro-location emitters.

In one embodiment, the emitter is secured to the interior of the wall box's wall plate. The emitters placement within the wall box helps reduce disruption caused by physical relocation and further helps reduce the interruption of power. In another embodiment, the emitter may be physically housed within an electrical receptacle body, such as a standard duplex receptacle.

According second aspect, the present invention provides an apparatus and method of configuring micro-location emitters inside a lighting fixture. Accordingly, the emitter receives power by harvesting the light generated by the lighting fixture.

In one embodiment, the emitter is secured between the fixture's light reflector and its light bulb so that any negative impact on the light pattern from the light bulb is minimized.

Consistent with a third aspect, the present invention provides an apparatus and method for securing micro-location emitters onto a transparent window. Accordingly, the emitter receives power by harvesting solar energy.

The present invention seeks to overcome or at least ameliorate one or more of several problems, including but not limited to, the enclosing and powering of micro-location emitters.

### BRIEF DESCRIPTION OF THE DRAWINGS

The present invention will now be described, in a non-limiting manner, referring to illustrations, where like reference numerals designate corresponding parts throughout the several views. The drawings are not necessarily drawn to scale, emphasis instead being placed upon clearly illustrating the principles of the present invention.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

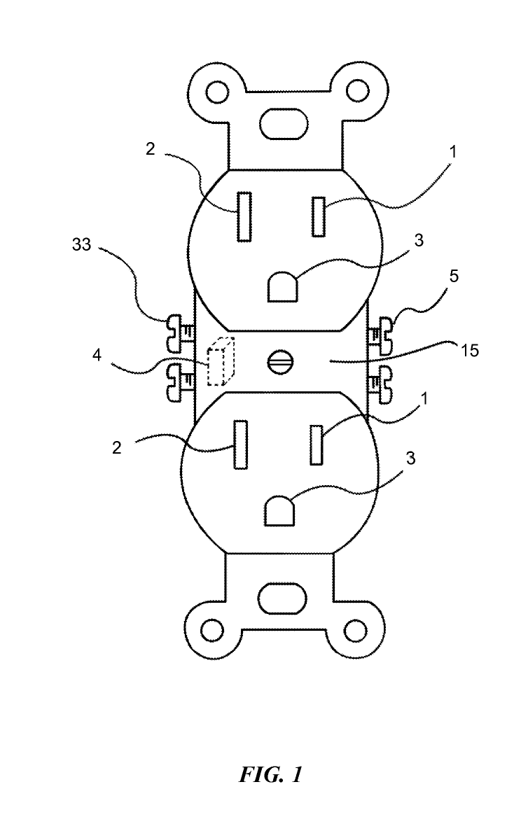

FIG. 1 illustrates a United States alternating current (A/C) power standard duplex receptacle having an emitter enclosed within its body.

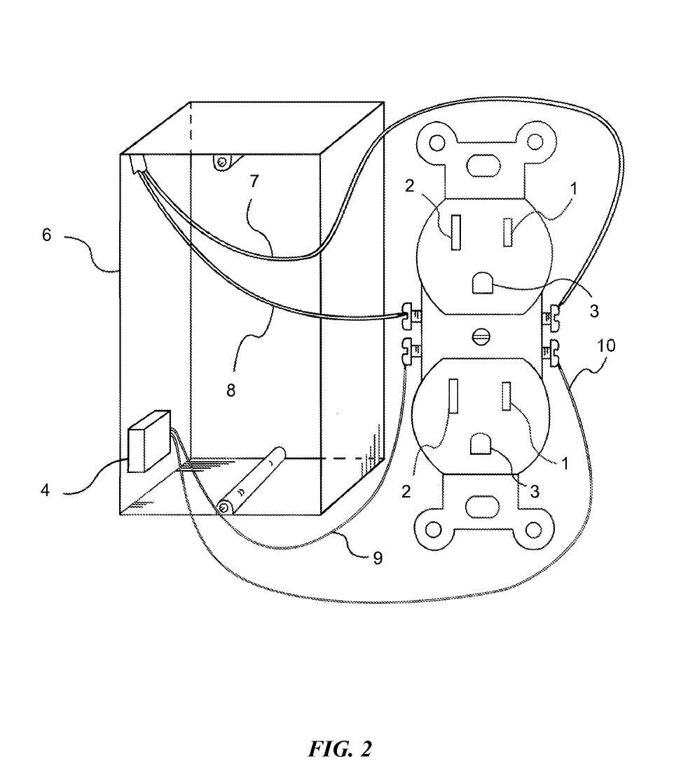

FIG. 2 illustrates a standard United States A/C power wall box containing an emitter connected in parallel to the A/C lines of a standard duplex receptacle (in twin duplex configuration), according to another embodiment of the invention.

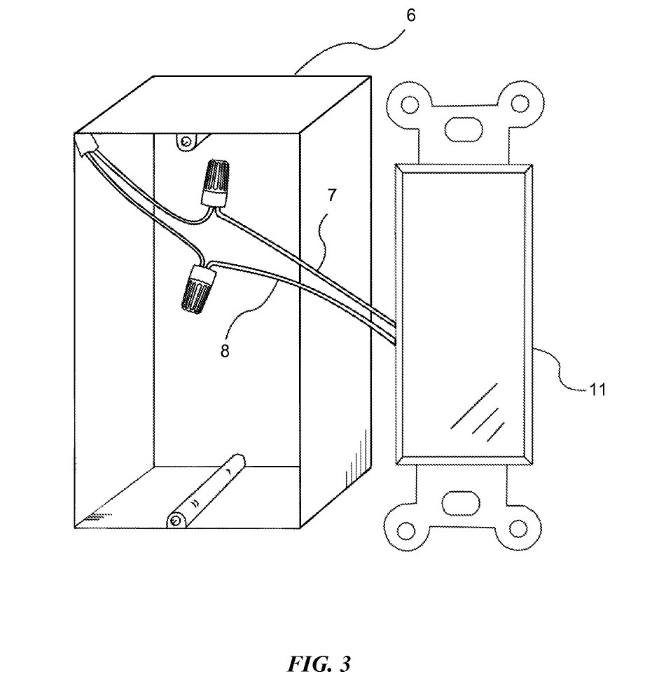

FIG. 3 illustrates a standard United States A/C power wall box with a full-sized receptacle emitter connected directly to the A/C lines, according to another embodiment of the invention.

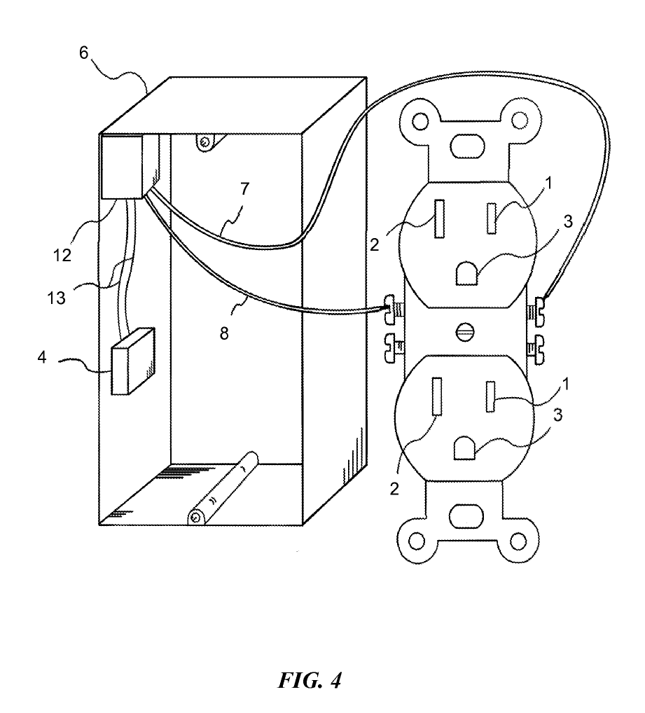

FIG. 4 illustrates a standard United States A/C power outlet wall box where the Bluetooth emitter is receiving power from the A/C lines via an induction pickup, according to another embodiment of the invention.

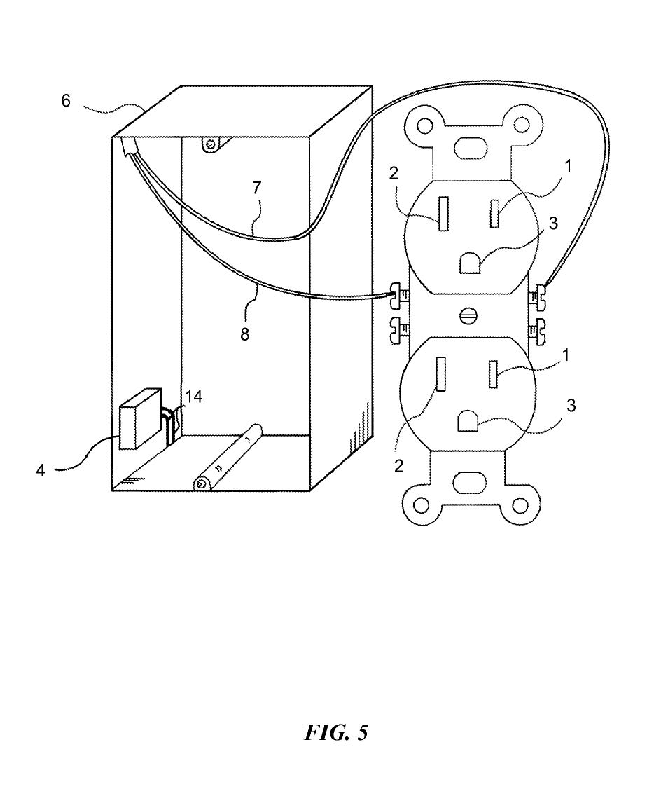

FIG. 5 illustrates a standard United States A/C power wall box containing a Bluetooth emitter powered by a tertiary power source, according to another embodiment of the invention.

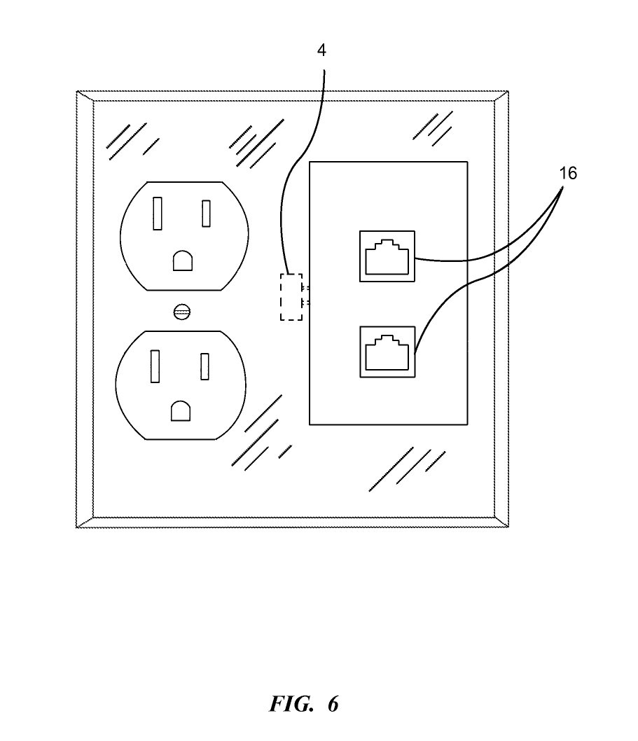

FIG. 6 illustrates a standard “dual-gang” configuration with one-half have having a duplex A/C power receptacle and the other having diplex network connection jacks wired to power an emitter, according to another embodiment of the invention.

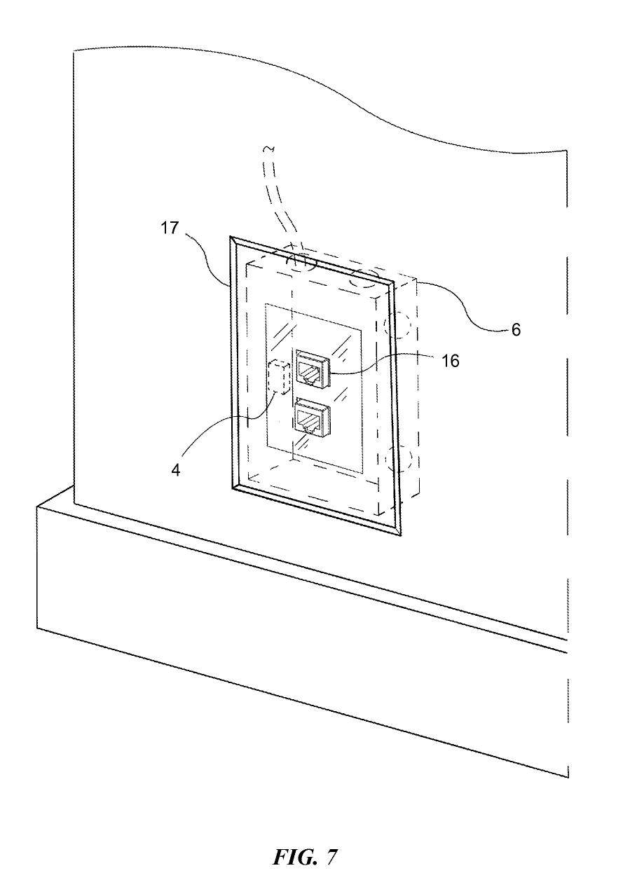

FIG. 7 illustrates a wall containing a wall box with duplex network connection jacks having an emitter secured to their wall plate, according to another embodiment of the invention.

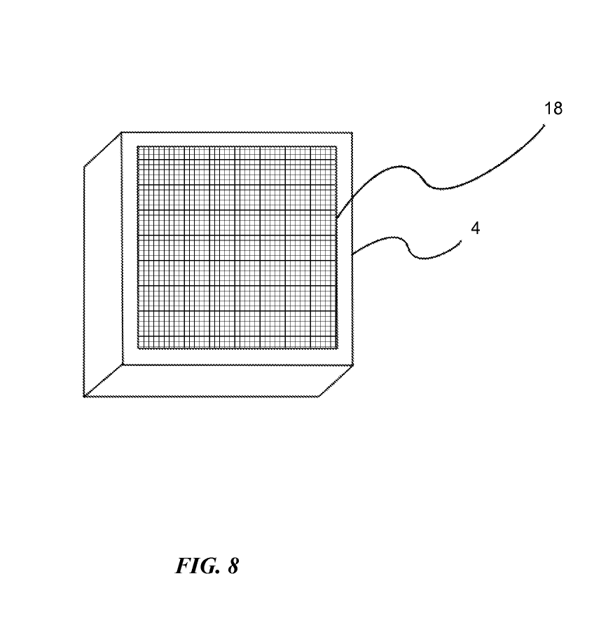

FIG. 8 illustrates an emitter having solar cell panel thereon, according to another embodiment of the invention.

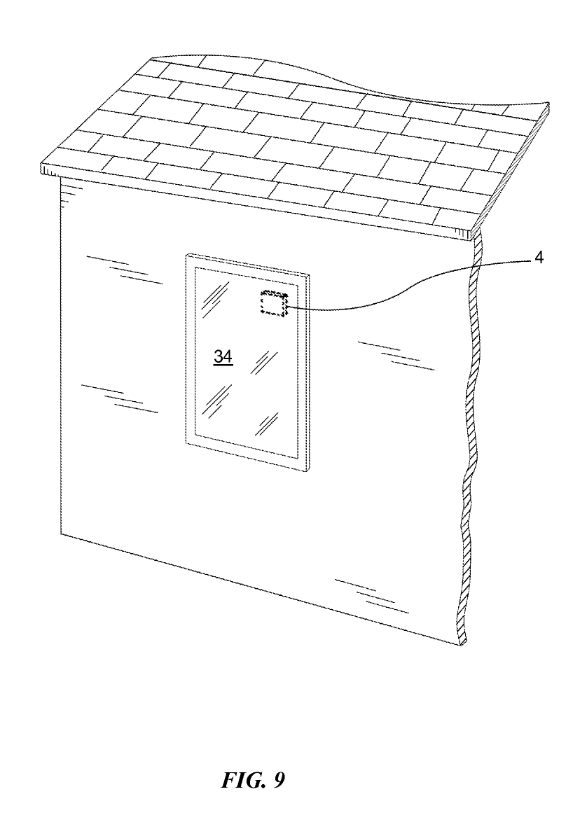

FIG. 9 illustrates the emitter of FIG. 8 secured to a window according to another embodiment of the invention.

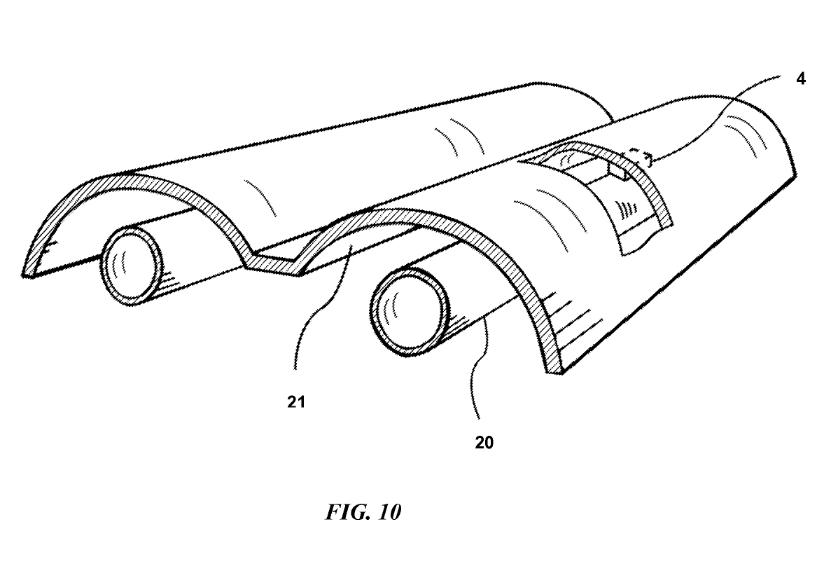

FIG. 10 illustrates a cross-section cut-a-way of a florescent light fixture with an emitter mounted on the reflector surface directly above one bulb, according to another embodiment of the invention.

### LIST OF REFERENCE NUMBERS

The following is a list of the major elements in the drawings.
1 Hot slot
2 Neutral slot
3 Ground slot
4 Emitter
5 Hot conductor terminal
6 Wall box
7 Hot wire
8 Neutral wire
9 Neutral emitter lead wire
10 Hot emitter lead wire
11 Full size receptacle emitter
12 Induction Pickup
13 Induction power supply lines
14 D/C alternate power feed
15 Receptacle body
16 Network connection jack
17 Wall box faceplate
18 Solar panel
19 Window
20 Light bulb
21 Light reflector
33 Neutral conductor terminal
34 Window

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

### MODE(S) FOR CARRYING OUT THE INVENTION

It is to be noted that the following exemplary embodiments are only illustrative and many alterations in the described embodiments are possible. Some embodiments of the invention will next be described with reference to the figures, wherein like numerals indicate corresponding parts throughout the several views.

FIG. 1 shows an emitter 4 configured inside a standard United States duplex electrical receptacle body 15. The duplex electrical receptacle body 15 is one of the most common electrical outlets in North America in buildings built since the mid-twentieth century. In some embodiments the receptacles may be on a common circuit, and in others, they may be wired with each receptacle on a separate circuit. The traditional slot orientation in residential buildings is with the ground slot 3 on the bottom, while in commercial buildings ground slot 3 is on top, per National Electrical Installation Standards (NECA) 130-2010.

Electrical receptacles normally are used to power electrical appliances. Appliances having a plug with 2 prongs are inserted their plug's prongs into hot slot 1 and neutral slot 2. Appliances having a plug with 3 prongs are conventionally inserted into all three slots, hot slot 1, neutral slot 2, and ground slot 3. Electrical receptacles are normally installed within a wall box 6, and have their hot conductor terminal 5 connected to a building structure's hot wire 7 and their neutral conductor terminal 33 connected to a building structure's neutral wire 8. A ground wire is often present (not shown). It is also common for electrical receptacles to have a decorating wall box faceplate 17 (shown in FIGS. 6 & 7). In one embodiment, the emitter 4 is commonly powered from hot conductor terminal 5 and neutral conductor terminal 33.

Emitters may require, for example, 3 volts Direct Current D/C, therefore any rectifying and stepping down of the A/C power can be accomplished, as necessary, through various adapters as is well known in the art.

Referring now to FIG. 2, shown is a standard United States power wall box 6 containing an emitter 4 and electrical receptacle. The emitter 4 is powered in parallel with Neutral emitter lead wire 9 to Neutral conductor terminal 33, and with hot emitter lead wire 10 to hot conductor terminal 5. The emitter 4 operates while it is contained within the wall box 6. In some embodiments, the emitter 4 may be secured directly to the outside of the wall box 6.

FIG. 3 illustrates a standard United States A/C power wall box 6 with a full-size emitter 11 connected to a building structure's hot wire 7 and neutral wire 8. The emitter is contained within the wall box 6 and has no A/C outlets. In one embodiment the face of full-size emitter 11 may be exposed through a wall plate 17 (not shown). In other embodiments, the full-size emitter 11 may alternatively be powered by a by any other tertiary power source.

FIG. 4 illustrates a wall box 6 where the emitter 4 is powered from a building structure's hot wire 7 and neutral wire 8 via induction pickup 12. According to this embodiment, the emitter 4 is wired to induction pickup 12 by induction power supply lines 13. Induction can be accomplished using various adapters as is well known in the art.

FIG. 5 illustrates a wall box 6 with the emitter 4 powered by a tertiary power source, for example, a secondary D/C power source that is wired to run to the receptacle.

FIG. 6 illustrates a standard “dual-gang” configuration with one half having network jacks 16 that also provide power to emitter 4. In this embodiment, the emitter 4 may be powered by Power-Over-Ethernet (POE). In accordance with this embodiment, emitter 4 may be secured to interior of wall plate 17.

FIG. 7 illustrates a standard “single-gang” wall-mounted configuration having duplex network connection jacks 16. In this embodiment, network connection jacks 16 provide power to emitter 4. In some embodiments, emitter 4 may be powered by POE. That is, the electrical power is supplied to emitter 4 over the network connection jack 16 wiring.

FIG. 8 shows an embodiment where emitter 4 further includes an integrated solar cell panel 18. The solar cell panel 18 allows emitter 4 to be powered through the harvesting of ambient or direct light. In some embodiments, a capacitor or rechargeable battery (not shown) may be further included in order to provide power to emitter 4 through intermittent periods when there is no light to harvest (e.g., because it is dark or the lights are off.) Accordingly, the harvested solar energy could be used for powering the emitter 4, and/or in some embodiments, to charge an onboard battery or capacitor for powering the emitter 4 during periods when there is no light to harvest.

FIG. 9 shows the emitter 4 of FIG. 8, secured on the interior of an external facing window 34. In this embodiment, the solar cell is facing the window's exterior surface in order to harvest exterior light. In alternative embodiments, the emitter 4 may be mounting directly to the ceiling (or wall) where it gathers the light reflected off the floor, walls, furniture etc.

FIG. 10 shows the emitter 4 of FIG. 8 mounted above a florescent light bulb 20 on the surface of its fixture's reflector 21. Preferably, the emitter 4 is positioned directly above the bulb 20 in such a manner that it will not interfere with the light pattern of florescent light bulb 20.

### LIST OF ACRONYMS

The following is a list of the acronyms used in the specification in alphabetical order.

A/C Alternating Current

D/C Direct Current

POE Power Over Ethernet

BLE Bluetooth Low Energy

A-GPS Assisted GPS

GPS Global Positioning System

SWAP Shared Wireless Access Protocol

UWB Dart Ultra Wideband

RFID Radio-frequency identification

WLAN Wireless local area network

NECA National Electrical Contractors Association

RFID Radio-frequency identification

UWB Dart Ultra Wideband

SWAP Shared Wireless Access Protocol

GPS Global Positioning System

A-GPS Assisted Global Positioning System

### Alternate Embodiments

In the foregoing specification, the invention has been described with reference to specific embodiments thereof. It will, however, be evident that various modifications and changes can be made thereto without departing from the broader spirit and scope of the invention as set forth in the appended claims. For example, the emitters may implement or conform to various versions of the Bluetooth® specification, for example, “Bluetooth Smart®” or “Bluetooth Low Energy®;” The emitters may be integrated within a fixture component or sub-component; and/or an emitter may be secured using, for example, with a magnet, self-stick tape, screws, or via any known methods.

The specification and drawings are, accordingly, to be regarded as illustrative rather than restrictive. Therefore, the scope of the claimed invention should be limited only by the appended claims.

What is claimed is:

1. A micro-location beacon positioning system, comprising:
one or more micro-location emitters 4, each micro-location emitter 4 being separately encapsulated within one or more standard electrical fixtures of an indoor environment; and
a mobile device configured to dynamically determine an approximation of its geographical position within said indoor environment based on a broadcast signal from said one or more emitters 4.

2. The micro-location beacon positioning system of claim 1, wherein said standard electrical fixtures of an indoor environment is a wall box 6.

3. The micro-location beacon positioning system of claim 2, wherein each one of said one or more micro-location emitters 4 are configured to broadcast their respective positioning information using a Bluetooth Low Energy (BLE) message.

4. The micro-location beacon positioning system of claim 2, wherein at least one of said one or more micro-location emitters 4 is embedded within the housing of a receptacle body 15, and said emitter 4 is configured to draw power from a hot conductor terminal 5 and a neutral conductor terminal 33 of said receptacle body 15.

5. The micro-location beacon positioning system of claim 3, wherein at least one of said one or more micro-location emitters 4 is mounted to the interior surface of a wall plate 17 of its respective wall box 6.

6. The micro-location beacon positioning system of claim 3, wherein said emitter 4 is configured to receive its power directly from a hot wire 7 and neutral wire 8 of said wall box 6.

7. The micro-location beacon positioning system of claim 3, wherein said emitter 4 is configured to its power from a wall box's existing power wiring by using an induction Pickup 12.

8. A micro-location beacon positioning system, comprising:
one or more micro-location emitters 4, at least one said micro-location emitter 4 mounted inside a lighting fixture of an indoor environment; and
a mobile device configured to dynamically determine an approximation of its geographical position within said indoor environment based on a broadcast signal from said one or more emitters 4.

9. The micro-location beacon positioning system of claim 8, wherein each one of said one or more micro-location emitters 4 are configured to broadcast their respective positioning information using a Bluetooth Low Energy (BLE) message.

10. The micro-location beacon positioning system of claim 9, wherein at least one of said one or more micro-location emitters 4 are configured with a solar panel 18 to receive power by harvesting the light generated by a light bulb 20 of the lighting fixture.

11. The micro-location beacon positioning system of claim 10, further comprising: a rechargeable power cell configured to power emitter 4 during intermittent periods when there is no light to harvest from said light bulb 20 of said lighting fixture.

12. A method of enclosing and powering a Bluetooth Low Energy (BLE) micro-location emitter 4 comprising the steps of:
securing said emitter 4 within an interior of a standard electrical wall box 6 in an indoor environment; and
wiring said emitter 4 to receive its power from a hot wire 7 and neutral wire 8 of said wall box 6; and
providing a mobile device configured to dynamically determine an approximation of its geographical position within said indoor environment based on a broadcast signal from one or more said emitter 4.

13. The method of claim 12, wherein the step of wiring further comprises:
receiving power from a hot wire 7 and neutral wire 8 of said wall box 6 with the use of an induction pickup 12.

14. The method of claim 12, wherein the step of securing further comprises:
securing said emitter directly onto the interior surface of a wall plate 17 of its respective wall box 6.
